(19) United States
(12) Patent Application Publication
(10) Pub. No.: US 2009/0240556 A1
(43) Pub. Date: Sep. 24, 2009

(54) ANTICIPATING MERCHANDISING TRENDS FROM UNIQUE COHORTS

(75) Inventors: Robert Lee Angell, Salt Lake City, UT (US); Robert R. Friedlander, Southbury, CT (US); James R. Kraemer, Santa Fe, NM (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/050,720

(22) Filed: Mar. 18, 2008

(51) Int. Cl. G06Q 10/00

(52) U.S. Cl. 705/10

(57) ABSTRACT

A computer implemented method, apparatus, and computer-usable program product for identifying marketing trends in unique cohort groups. Information describing a plurality of unique cohort groups associated with a public environment is retrieved. Each member of a cohort group in the plurality of unique cohort groups shares at least one common attribute. Sets of attributes associated with the plurality of unique cohort groups are identified. The sets of attributes are analyzed by a cohort trend detection engine to identify attribute trends associated with the sets of attributes and a frequency of occurrence of the attribute trends in the plurality of unique cohort groups to form current attribute trends. In response to a query to an inference engine requesting inferences associated with the marketing trends, inferences describing future occurrences of the attributes in the plurality of cohort groups are received to form a set of future attribute trends. A set of marketing trends are generated using the current attribute trends and the set of future attribute trends. The set of marketing trends describes probable future marketing trends in the given environment.

### BACKGROUND OF THE INVENTION

1. Field of the Invention

The present invention is related generally to an improved data processing system, and in particular to a method and apparatus for identifying merchandising trends. More particularly, the present invention is directed to a computer implemented method, apparatus, and computer-usable program code for identifying merchandising trends in unique cohort groups using sensory data gathered by multimodal sensor devices.

2. Background Description

A cohort is a group of people or objects that share a common characteristics or experience. For example, a group of people born in 1980 may form a birth cohort. A cohort may include one or more sub-cohorts. For example, the birth cohort of people born in 1980 may include a sub-cohort of people born in 1980 in Salt Lake City, Utah. A sub-sub-cohort may include people born in 1980 in Salt Lake City, Utah to low income, single parent households.

Cohort groups are generated based on one or more attributes of the members of the cohort groups. The information used to identify the attributes of members of the cohort groups, are typically provided by the members of the cohort groups. Merchandising trends can be determined based on many different and disparate cohort groups. However, this information describing characteristics and attributes of members of cohort groups may be voluminous, dynamically changing, and/or unknown to the member of the cohort group. Thus, it may be difficult and time consuming for an individual to access all the information necessary to generate unique cohort groups. Moreover, unique cohort groups are typically sub-optimal because individuals lack the skills, time, knowledge, and/or expertise needed to gather cohort attribute information.

### BRIEF SUMMARY OF THE INVENTION

According to one embodiment of the present invention, a computer implemented method, apparatus, and computer-usable program product for identifying marketing trends in unique cohort groups. Information describing a plurality of unique cohort groups associated with a public environment is retrieved. Each member of a cohort group in the plurality of unique cohort groups shares at least one common attribute. Sets of attributes associated with the plurality of unique cohort groups are identified. The sets of attributes are analyzed by a cohort trend detection engine to identify attribute trends associated with the sets of attributes and a frequency of occurrence of the attribute trends in the plurality of unique cohort groups to form current attribute trends. In response to a query to an inference engine requesting inferences associated with the marketing trends, inferences describing future occurrences of the attributes in the plurality of cohort groups are received to form a set of future attribute trends. A set of marketing trends are generated using the current attribute trends and the set of future attribute trends. The set of marketing trends describes probable future marketing trends in the given environment.

### BRIEF DESCRIPTION OF THE SEVERAL VIEWS OF THE DRAWINGS

FIG. 1 is a block diagram of a network of data processing system in which illustrative embodiments may be implemented;

FIG. 2 is a block diagram of a data processing system in which illustrative embodiments may be implemented;

FIG. 3 is a block diagram of a set of multimodal sensors located in a plurality of locations is depicted in accordance with an illustrative embodiment;

FIG. 4 is a block diagram of a cohort trend detection system in accordance with an illustrative embodiment;

FIG. 5 is a block diagram illustrating an inference engine in accordance with an illustrative embodiment;

FIG. 6 is a block diagram of a set of attribute trends in accordance with an illustrative embodiment;

FIG. 7 is a block diagram of a unique plant cohort group in accordance with an illustrative embodiment;

FIG. 8 is a block diagram of a pedestrian cohort group in accordance with an illustrative embodiment;

FIG. 9 is a block diagram of another pedestrian cohort group in accordance with an illustrative embodiment; and

FIG. 10 is a flowchart illustrating a process for identifying marketing trends in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

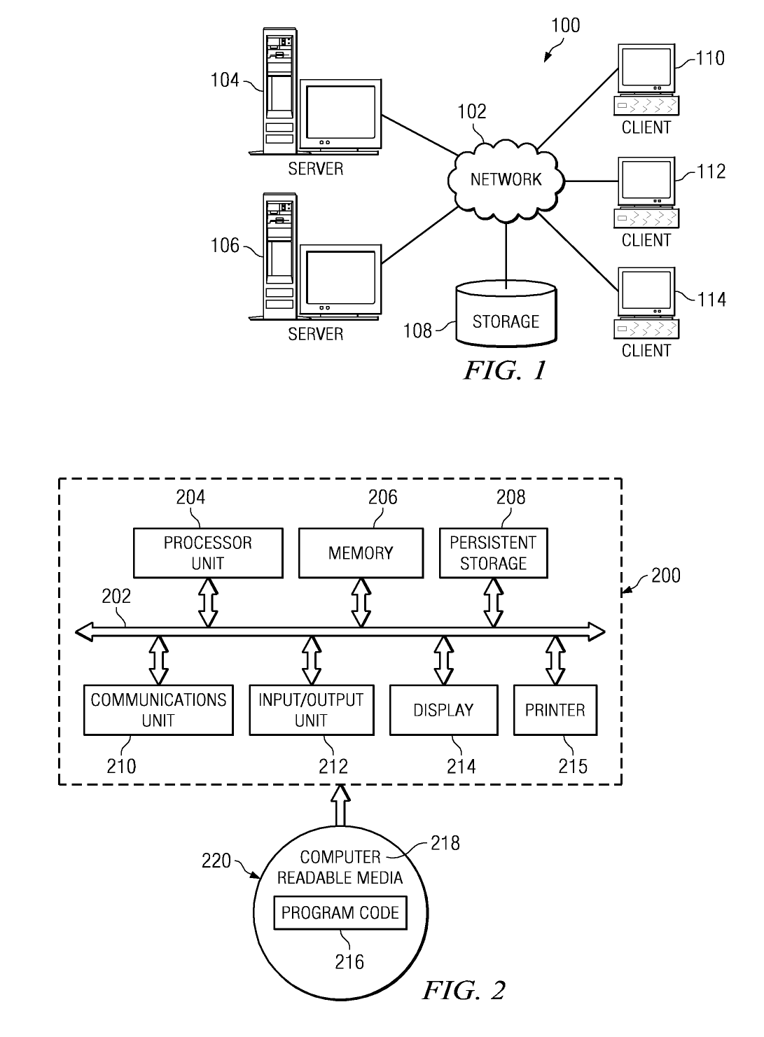

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user. Printer 215 is a device for printing output on paper or another hardcopy format.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer-program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

According to one embodiment of the present invention, a computer implemented method, apparatus, and computer usable program product for identifying marketing trends in unique cohort groups. Information describing a plurality of unique cohort groups associated with a public environment is retrieved. Each member of a cohort group in the plurality of unique cohort groups shares at least one common attribute. Sets of attributes associated with the plurality of unique cohort groups are identified. The sets of attributes are analyzed by a cohort trend detection engine to identify attribute trends associated with the sets of attributes and a frequency of occurrence of the attribute trends in the plurality of unique cohort groups to form current attribute trends. In response to a query to an inference engine requesting inferences associated with the marketing trends, inferences describing future occurrences of the attributes in the plurality of cohort groups are received to form a set of future attribute trends. A set of marketing trends are generated using the current attribute trends and the set of future attribute trends. The set of marketing trends describes probable future marketing trends in the given environment.

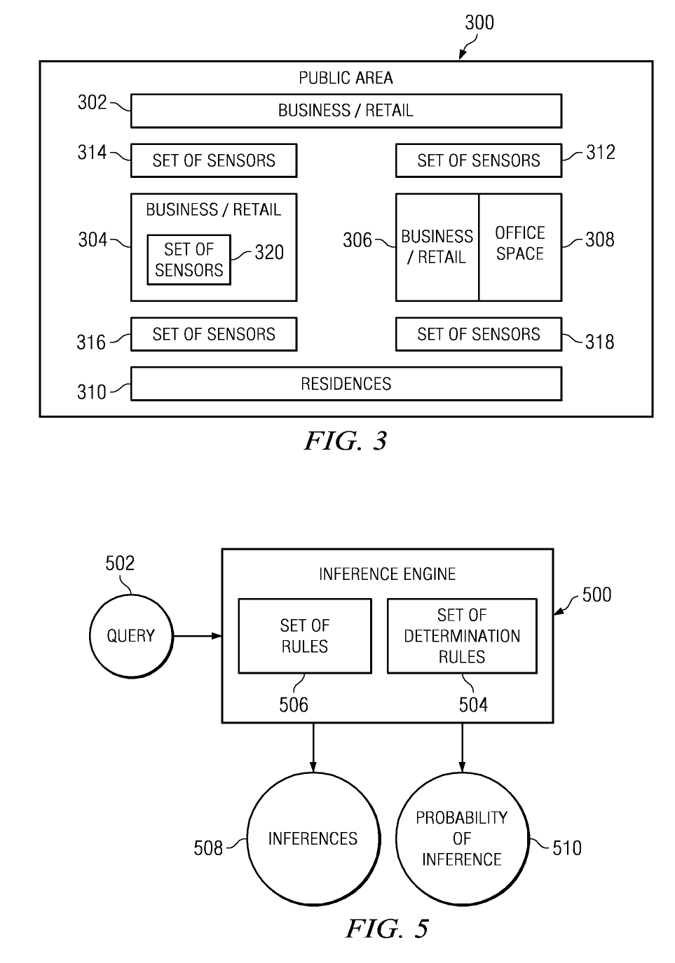

Turning now to FIG. 3, a block diagram of a set of multimodal sensors located in a plurality of locations is depicted in accordance with an illustrative embodiment. Public area 300 is an area that is open to the public, viewable by the public, accessible to the public, and/or publicly owned. Business/retail 302-306 are commercial retail establishments, such as a department store, grocery store, clothing store, or any other type of business or retail establishment. Residences 310 are residences, such as single family homes, apartments, condominiums, duplexes, or other types of residences.

Set of sensors 312-320 are sets of multimodal sensors, such as set of multimodal sensors 118 in FIG. 1. Set of sensors 312-320 may be located in any public and/or privately owned locations. In this example, set of sensors 312-320 are located in public area 300. Set of sensors 320 is located in business/retail 304. Thus, in this example, set of sensors 312-320 are located in a combination of public and privately owned spaces. However, set of sensors 312-320 may also be located entirely in public area 300. In another embodiment, set of sensors 312-320 are located in two or more different business/retail establishments, such as business/retail 302-306. Although in this embodiment, set of sensors 312-320 are only located in public spaces, multimodal sensors may optionally also be located in business/retail 304, office space 308, residences 310, and/or any other location.

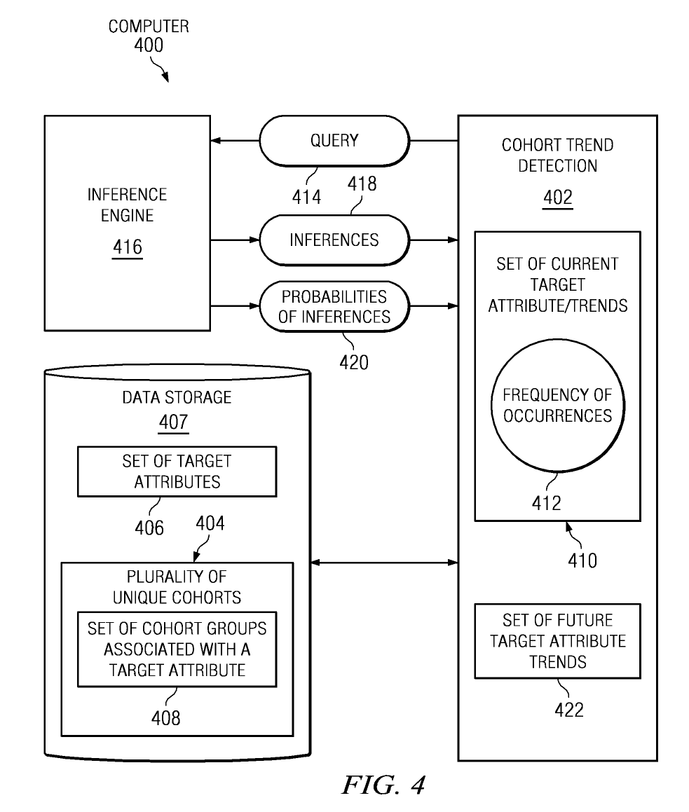

FIG. 4 is a block diagram of a cohort trend detection system in accordance with an illustrative embodiment. Computer 400 may be implemented using any type of computing device, such as a server, a client computer, a laptop computer, a personal digital assistant (PDA), or any other computing device depicted in FIGS. 1 and 2.

Cohort trend detection 402 is a software component for anticipating merchandising trends based on information describing unique cohort groups. Cohort trend detection 402 receives information describing plurality of unique cohorts 404. Each member of a cohort group in plurality of unique cohorts 404 shares at least one common attribute. The information may be received from one or more sources in real time as the information is generated. The information may also be received from a data storage device, such as data storage 407.

Data storage 407 may be implemented as any type of device for storing data, such as, without limitation, a hard drive, a flash memory, a main memory, read only memory (ROM), a random access memory (RAM), or any other type of data storage device. Data storage may be implemented in a single data storage device or a plurality of data storage devices. Data storage 407 may be a data storage device that is local to computer 400 or a device located remotely to computer 400. If data storage 400 comprises one or more remote data storage device, the remote data storage devices are accessed via a network connection, such as network 102 in FIG. 1. Data storage 407 may be a central data storage. Data storage 407 may also be a de-centralized data storage, such as, without limitation, a grid data processing system, a federated database, and/or any other type of distributed data storage device.

Cohort trend detection 402 identifies set of target attributes 406. Set of target attributes 406 is a set of two or more attributes of interest associated with one or more cohort groups in plurality of unique cohort groups 404. An attribute of interest may be an attribute associated with coats worn by cohorts, baseball caps worn by teenagers, or any other attributes. Cohort trend detection 402 analyzes set of target attributes 406 and identifies set of current target attribute trends 410. Set of current target attribute trends 410 includes a frequency of occurrences 412 of the attribute trends in the plurality of unique cohort groups 410. Frequency of occurrences 412 identifies a rate at which a given attribute occurs in one or more members of a given cohort group. A rate of occurrences is the number of times a given attribute is identified in one or more cohorts over a given period of time. Frequency of occurrences 412 may also identify a rate at which the given attribute occurs in one or more members of a set of two or more cohort groups in plurality of unique cohorts 404. Cohort trend detection 402 may also identify the cohort groups associated with a target attribute 408.

Set of cohort groups associated with a target attribute 408 is one or more cohort groups in which a target attribute is identified. For example, if the target attribute is pink baseball caps, cohort trend detection 402 identifies a number of times a member of a cohort group is identified wearing a pink baseball cap. Set of cohort groups associated with a target attribute 408 in this example may include male cohorts, teenage cohorts, and/or any other cohort group in which members of the cohort group are identified wearing pink hats.

Cohort trend detection 402 sends query 414 to inference engine 416. Query 414 is a request for probable future frequency of occurrences of the attribute. In response to receiving query 414, inference engine 416 generates inferences 418 and probabilities of inferences 420. Inferences 418 are conclusions based on a comparison of facts within data storage 407. Probabilities of inferences 420 are probabilities of the likelihood that a particular inference is true, or alternatively, the probability that the particular inference is false. Inferences 418 and probabilities of inferences 420 are used by cohort trend detection 402 to identify set of future target attribute trends 422. Set of future attribute trends 422 comprises one or more probable future occurrences of target attributes and/or probable future frequencies of the target attributes.

Cohort trend detection 402 may generate a set of marketing trends using set of current target attribute trends 410 and set of future target attribute trends 422. The set of marketing trends describes probable future marketing trends in a given environment. The given environment may be the environment in which the occurrences of the attribute were identified. The given environment may also be an environment that is remote to the environment in which the occurrences of the attribute were identified.

FIG. 5 is a block diagram illustrating an inference engine in accordance with an illustrative embodiment. Inference engine 500 is a software component for generating inferences and probabilities of inferences using medical data associated with a target individual, such as inference engine 332 in FIG. 3.

Query 502 is a request for a fact, such as probable medications and/or treatments that may be required by a target individual. Query 502 may be a single query or a set of two or more queries. In response to receiving query 502, inference engine 500 uses query 502 as a frame of reference to find relevant information in a data storage or central database. A frame of reference is an anchor datum or set of data that is used to limit which data are searched in the central database. The frame of reference is used to establish set of determination rules 504.

Set of determination rules 504 is a set of rules that are used to generate set of rules 506. Set of rules 506 specifies information to be searched. For example, if query 502 requests probable antibiotics that may be needed, set of rules 506 may specify searching for past history of infections in the target individual that required antibiotics. Set of determination rules 504 may also specify certain interrelationships between data sets that will be searched. Inference engine 500 uses data in a centralized database to derive inference 508 and probability of inference 510 based on comparison of data within the centralized database according to set of rules 506. Inference engine 500 does not compare the entirety of the data in the central database with every possible combination in order that limited computing resources can execute desired queries.

The central database is a database for storing target data associated with a target individual, such as, without limitation, data storage 407 in FIG. 4. The central database stores any data associated with the target attribute and/or cohort groups. Inferences 508 are inferences generated by inference engine 500. Inferences 508 include inferences regarding possible future occurrences of one or more target attributes in the given environment and/or future occurrences of the one or more target attributes in a different environment. The inferences may be true or false. A probability of inferences 510 indicates the likelihood or percentage chance that each inference in inferences 508 is true or false.

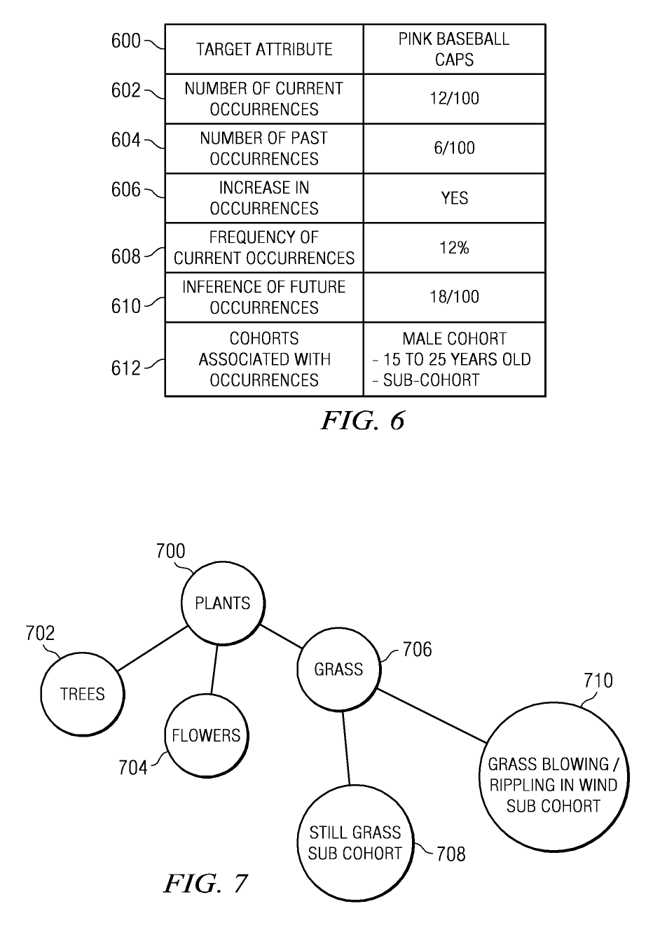

FIG. 6 is a block diagram of a set of attribute trends in accordance with an illustrative embodiment. Target attribute 600 is an attribute or characteristic of interest. Number of current occurrences 602 is a number of times target attribute 600 is identified in association with a member of a cohort group. For example, if the target attribute is dogs with electronic identification tags, number of current occurrences 602 includes the number of dogs with electronic identification tags identified in a given area within a given time interval. Number of past occurrences 604 is a number of times the target attribute is identified in association with cohorts in a given area during a past interval of time. Increase in occurrences 606 is a field for indicating whether the number of occurrences of a particular attribute are increasing or decreasing.

Frequency of occurrences 608 is a rate of occurrences of the target attribute. The frequency of occurrences 608 is the number of times the target attribute is identified in a given area for a specified amount of time. Inference of future occurrences 610 is an inference of a number of future occurrences of the target attribute that is probable or likely to occur. Cohorts associated with occurrences 612 is a field that identifies cohort groups and/or specific members of cohort groups that are associated with occurrences of the target attribute.

Thus, if the target attribute is pink hats and the occurrences of pink hats among cohort groups is decreasing, a determination may be made that the fashion trend of wearing pink hats is decreasing and going out of style. Likewise, if occurrences of the target attribute are increasing, a cohort trend detection may determine that a trend of wearing pink hats is beginning or growing in acceptance among the cohort groups.

FIG. 7 is a block diagram of a unique plant cohort group in accordance with an illustrative embodiment. Plants 700 is a cohort group of plants, such as trees, flowers, and grass. Plants 700 may include one or more sub-cohorts within the plants cohort group, such as, without limitation, trees 702 sub-cohort group, flowers 704 sub-cohort group, and/or grass 706 sub-cohort group. A sub-cohort group may include one or more sub-subcohort groups, such as, without limitation, still grass sub-cohort 708 and grass blowing/rippling in wind sub-cohort 710. Still grass sub-cohort 708 and grass blowing/rippling in wind sub-cohort 710 are sub-cohorts of grass 706 and sub-sub-cohorts of plants 700.

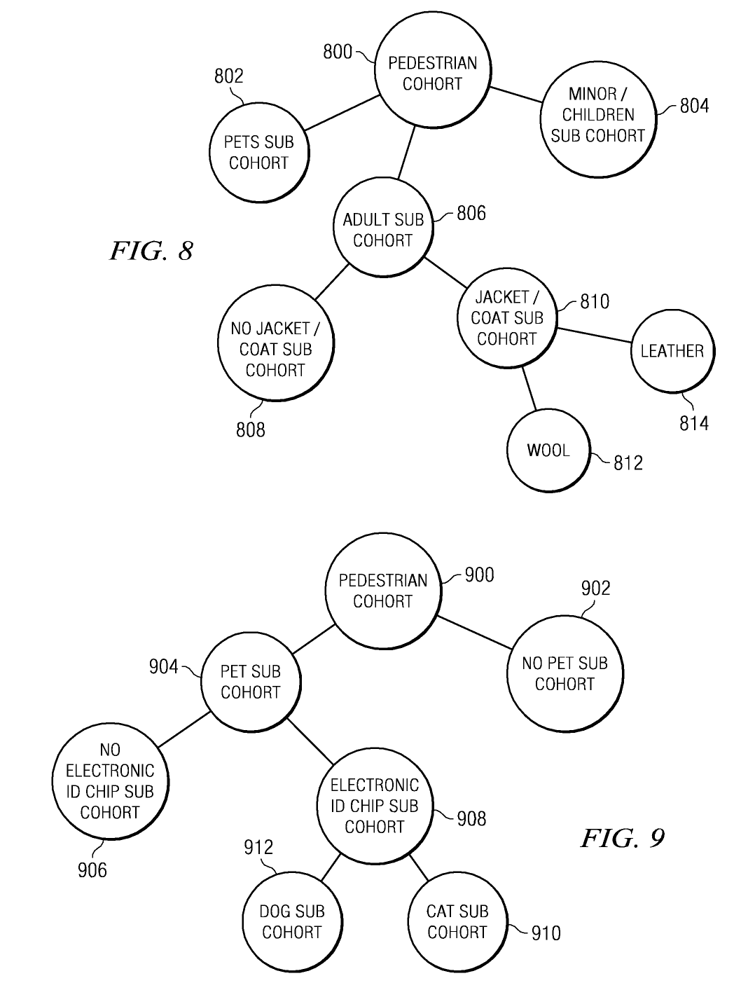

FIG. 8 is a block diagram of a pedestrian cohort group in accordance with an illustrative embodiment. Pedestrian cohort 800 is a cohort group of pedestrians walking within a given area. Pedestrian cohort 800 is generated by a cohort generation engine using cohort attributes based on multimodal sensory data, such as attributes 410 in FIG. 4. In this example, pedestrian cohort 800 comprises pets sub-cohort 802 of pets walking in the area, adult sub-cohort 806, group of human adults walking in the given area, and minor/children sub-cohort group 804 of children walking in the given area. Adult sub-cohort 806 comprises no jacket/coat sub-cohort 808 group of cohorts that are not wearing a coat or jacket and jacket/coat sub-cohort 810 of adult pedestrians that are wearing a coat or jacket. Jacket/coat sub cohort 810 further includes wool 812 sub-cohort of adult pedestrians wearing a wool jacket or coat and leather 814 sub-cohort group of adult pedestrians wearing a leather jacket or leather coat. The cohorts are generated using multimodal sensory data, such as digital video camera data identifying the type of coat or jacket worn by pedestrians, or any other type of sensory data capable of being used to identify the type of coats and/or jackets worn by adult pedestrians in a given area.

FIG. 9 is a block diagram of another pedestrian cohort group in accordance with an illustrative embodiment. Pedestrian cohort 900 is a cohort group of pedestrians walking in a given area. Pedestrian cohort 900 is generated using multimodal sensory data transmitted to a central data processing system over a network. In this example, pedestrian cohort 900 comprises pet sub-cohort 904 group of pedestrians walking with a pet and no pet sub-cohort 902 group of pedestrians walking without a pet. Pet sub-cohort 904 in this example includes, without limitation, no electronic identification chip sub-cohort 906 of pedestrians walking with pets that do not have an electronic identification chip associated with their pet and electronic identification chip sub-cohort 908 group of pedestrians walking with a pet that does have an electronic identification chip. The electronic identification chip sub-cohort 908 may further be divided into a dog sub-cohort 912 of dogs walking in the given area with an electronic identification chip and cat sub-cohort 910 of cats having electronic identification chips that are walking in the given area. This information may be used, without limitation, to identify potential customers of pet products and to identify the affluence or amount of spending that a customer may be willing to spend on pet products.

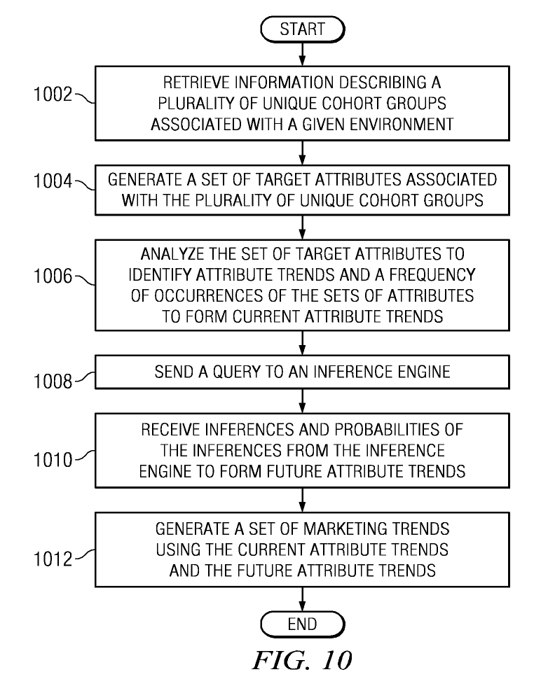

FIG. 10 is a flowchart illustrating a process for identifying marketing trends in accordance with an illustrative embodiment. The process in FIG. 10 is implemented by software for identifying current and probable future occurrences of target attributes, such as cohort trend detection 402 in FIG. 4.

Information describing a plurality of unique cohort groups associated with a given environment is retrieved (step 1002). A set of target attributes associated with the plurality of unique cohort groups is generated (step 1004). The set of target attributes is analyzed to identify attribute trends and a frequency of occurrences of the set of attributes to form current attribute trends (step 1006). A query is sent to an inference engine (step 1008). Inference and probabilities of the inferences are received from the inference engine to form future attribute trends (step 1010). A set of marketing trends is generated using the current attribute trends and the future attribute trends (step 1012) with the process terminating thereafter.

According to one embodiment of the present invention, a computer implemented method, apparatus, and computer usable program product for identifying marketing trends in unique cohort groups. Information describing a plurality of unique cohort groups associated with a public environment is retrieved. Each member of a cohort group in the plurality of unique cohort groups shares at least one common attribute. Sets of attributes associated with the plurality of unique cohort groups are identified. The sets of attributes are analyzed by a cohort trend detection engine to identify attribute trends associated with the sets of attributes and a frequency of occurrence of the attribute trends in the plurality of unique cohort groups to form current attribute trends. In response to a query to an inference engine requesting inferences associated with the marketing trends, inferences describing future occurrences of the attributes in the plurality of cohort groups are received to form a set of future attribute trends. A set of marketing trends are generated using the current attribute trends and the set of future attribute trends. The set of marketing trends describes probable future marketing trends in the given environment.

From many different and disparate cohort sets, the cohort trend detection makes a determination of merchandising trends. Currently, this cannot be determined outside a single store/entity environment. However, the cohort trend detection identifies current and future marketing trends using cohort information gathered in a plurality of locations using a plurality of multimodal sensors to enable cohort trends to be detected based on a variety of disparate sensor data. The cohort trend detection takes information describing previously captured cohorts and creates sets of cohort attributes. The cohort trend detection uses statistical, data mining, and other technical methods to spot merchandising trends automatically and without intervention by a human user.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method identifying marketing trends in unique cohort groups, the computer implemented method comprising:
retrieving information describing a plurality of unique cohort groups associated with a public environment, wherein each member of a cohort group in the plurality of unique cohort groups shares at least one common attribute;
identifying sets of attributes associated with the plurality of unique cohort groups;
analyzing the sets of attributes by a cohort trend detection engine to identify attribute trends in the sets of attributes and a frequency of occurrence of the attribute trends in the plurality of unique cohort groups to form current attribute trends;
retrieving inferences describing future occurrences of the attributes in the plurality of cohort groups to form a set of future attribute trends; and
generating a set of marketing trends using the current attribute trends and the set of future attribute trends, wherein the set of marketing trends describes probable future marketing trends in the given environment.

2. The computer implemented method of claim 1 wherein the set of current attribute trends comprises a frequency of occurrences of a given attribute across the plurality of unique cohort groups over a given time interval, and wherein the given attribute is associated with at least one cohort group in the plurality of unique cohort groups.

3. The computer implemented method of claim 1 further comprising:
sending a query to an inference engine requesting the inferences describing the future occurrences of the attributes.

4. The computer implemented method of claim 1 wherein public environment is an area in a first location and wherein the set of marketing trends describes probable future marketing trends in a second location that is remote from the first location.

5. The computer implemented method of claim 1 wherein the plurality of unique cohort groups is pre-generated using multimodal sensory data from a set of multimodal sensors in a public environment, wherein the set of multimodal sensors are associated with a network, and wherein the multimodal sensory data is received by a data processing system from the set of multimodal sensors over the network.

6. The computer implemented method of claim 1 further comprising:
predicting future fashion trends in a given location using the set of marketing trends.

7. The computer implemented method of claim 1 wherein the given environment comprises a public area and a set of retail environments.

8. The computer implemented method of claim 1 wherein analyzing the sets of attributes by a cohort trend detection engine further comprises:
analyzing the sets of attributes using at least one of a statistical method, a data mining method, a causal model, a mathematical model, a marketing model, a behavioral model, a psychological model, a sociological model, or a simulation model.

9. The computer implemented method of claim 1 wherein the sets of attributes comprises attributes identified in the plurality of unique cohort groups over a predetermined period of time, and wherein the sets of attributes are associated with sub-cohort groups within the plurality of unique cohort groups.

10. The computer implemented method of claim 1 wherein identifying sets of attributes associated with the plurality of unique cohort groups further comprises:
processing multimodal sensory data gathered by a set of multimodal sensors to identify the sets of attributes, wherein the set of multimodal sensors comprises at least one of a set of global positioning satellite receivers, a set of infrared sensors, a set of microphones, a set of motion detectors, a set of chemical sensors, a set of biometric sensors, a set of pressure sensors, a set of temperature sensors, a set of metal detectors, a set of radar detectors, a set of photosensors, a set of seismographs, and a set of anemometers.

11. A computer program product for identifying marketing trends in unique cohort groups, the computer program product comprising:
a computer-readable medium;
program code stored on the computer-readable medium for retrieving information describing a plurality of unique cohort groups associated with a public environment, wherein each member of a cohort group in the plurality of unique cohort groups shares at least one common attribute;
program code stored on the computer-readable medium for identifying sets of attributes associated with the plurality of unique cohort groups;
program code stored on the computer-readable medium for analyzing the sets of attributes by a cohort trend detection engine to identify attribute trends in the sets of attributes and a frequency of occurrence of the attribute trends in the plurality of unique cohort groups to form current attribute trends;
program code stored on the computer-readable medium for retrieving inferences describing future occurrences of the attributes in the plurality of cohort groups to form a set of future attribute trends; and
program code stored on the computer-readable medium for generating a set of marketing trends using the current attribute trends and the set of future attribute trends, wherein the set of marketing trends describes probable future marketing trends in the given environment.

12. The computer program product of claim 11 wherein the set of current attribute trends comprises a frequency of occurrences of a given attribute across the plurality of unique cohort groups over a given time interval, and wherein the given attribute is associated with at least one cohort group in the plurality of unique cohort groups.

13. The computer program product of claim 11 wherein public environment is an area in a first location and wherein the set of marketing trends describes probable future marketing trends in a second location that is remote from the first location.

14. The computer program product of claim 11 wherein the plurality of unique cohort groups is pre-generated using multimodal sensory data from a set of multimodal sensors in a public environment, wherein the set of multimodal sensors are associated with a network, and wherein the multimodal sensory data is received by a data processing system from the set of multimodal sensors over the network.

15. The computer program product of claim 11 further comprising:
program code stored on the computer-readable medium for predicting future fashion trends in a given location using the set of marketing trends.

16. The computer program product of claim 11 wherein analyzing the sets of attributes by a cohort trend detection engine further comprises:
program code stored on the computer-readable medium for analyzing the sets of attributes using at least one of a statistical method, a data mining method, a causal model, a mathematical model, a marketing model, a behavioral model, a psychological model, a sociological model, or a simulation model.

17. The computer program product of claim 11 wherein identifying sets of attributes associated with the plurality of unique cohort groups further comprises:
program code stored on the computer-readable medium for processing multimodal sensory data gathered by a set of multimodal sensors to identify the sets of attributes, wherein the set of multimodal sensors comprises at least one of a set of global positioning satellite receivers, a set of infrared sensors, a set of microphones, a set of motion detectors, a set of chemical sensors, a set of biometric sensors, a set of pressure sensors, a set of temperature sensors, a set of metal detectors, a set of radar detectors, a set of photosensors, a set of seismographs, and a set of anemometers.

18. An apparatus comprising:
a bus system;
a communications system coupled to the bus system;
a memory connected to the bus system, wherein the memory includes computer-usable program code; and
a processing unit coupled to the bus system, wherein the processing unit executes the computer-usable program code to retrieve information describing a plurality of unique cohort groups associated with a public environment, wherein each member of a cohort group in the plurality of unique cohort groups shares at least one common attribute, identify sets of attributes associated with the plurality of unique cohort groups, analyze the sets of attributes by a cohort trend detection engine to identify attribute trends in the sets of attributes and a frequency of occurrence of the attribute trends in the plurality of unique cohort groups to form current attribute trends, retrieve inferences describing future occurrences of the attributes in the plurality of cohort groups to form a set of future attribute trends; and generate a set of marketing trends using the current attribute trends and the set of future attribute trends, wherein the set of marketing trends describes probable future marketing trends in the given environment.

19. The apparatus of claim 18 wherein the set of current attribute trends comprises a frequency of occurrences of a given attribute across the plurality of unique cohort groups over a given time interval, and wherein the given attribute is associated with at least one cohort group in the plurality of unique cohort groups.

20. The apparatus of claim 18 wherein public environment is an area in a first location and wherein the set of marketing trends describes probable future marketing trends in a second location that is remote from the first location.

21. The apparatus of claim 18 wherein the processor unit further executes the computer-usable program code to predict future fashion trends in a given location using the set of marketing trends.

22. The apparatus of claim 18 wherein analyzing the sets of attributes by a cohort trend detection engine, and wherein the processor unit further executes the computer-usable program code to analyze the sets of attributes using at least one of a statistical method, a data mining method, a causal model, a mathematical model, a marketing model, a behavioral model, a psychological model, a sociological model, or a simulation model.

23. A data processing system for identifying marketing trends in unique cohort groups, comprising:
a data storage device, wherein the data storage device stores a plurality of unique cohort groups and a set of target attributes, wherein each member of a cohort group in the plurality of unique cohort groups shares at least one common attribute;
a cohort trend detection engine, wherein the cohort trend detection engine identifies a set of target attributes associated with the plurality of unique cohort groups, identifies attribute trends in the sets of attributes and a frequency of occurrence of the attribute trends in the plurality of unique cohort groups to form current attribute trends; retrieves inferences describing future occurrences of the attributes in the plurality of cohort groups to form a set of future attribute trends, and generate a set of marketing trends using the current attribute trends and the set of future attribute trends, wherein the set of marketing trends describes probable future marketing trends in the given environment.

24. The data processing system of claim 23 further comprising:
an inference engine, wherein the inference engine generates the inferences describing the future occurrences of the attributes in the plurality of cohort groups.

25. The data processing system of claim 23 further comprising:
a set of multimodal sensors, wherein the set of multimodal sensors generates multimodal sensory data that is used to identify the sets of attributes, and wherein the set of multimodal sensors comprises at least one of a set of global positioning satellite receivers, a set of infrared sensors, a set of microphones, a set of motion detectors, a set of chemical sensors, a set of biometric sensors, a set of pressure sensors, a set of temperature sensors, a set of metal detectors, a set of radar detectors, a set of photosensors, a set of seismographs, and a set of anemometers.
